(19) United States
(12) Patent Application Publication
(10) Pub. No.: US 2003/0112382 A1
(43) Pub. Date: Jun. 19, 2003

(54) Liquid crystal display device

(76) Inventors: Takuya Takahashi, Hitachi (JP); Isao Ikuta, Iwaki (JP); Katsumi Tamura, Hitachi (JP); Youichi Sakaki, Hitachinaka (JP); Ken-Ichi Onisawa, Hitachinaka (JP); Masahiko Ando, Hitachinaka (JP)

Correspondence Address: DICKSTEIN SHAPIRO MORIN & OSHINSKY LLP, 2101 L STREET NW, WASHINGTON, DC, 20037-1526, US

(21) Appl. No.: 09/956,343

(22) Filed: Sep. 20, 2001

(30) Foreign Application Priority Data
Feb. 27, 2001 (JP) 2001-051450

(51) Int. Cl. G02F 1/136

(52) U.S. Cl. 349/43

(57) ABSTRACT

A liquid crystal display device in which at least one of the scanning line GL, data line DL, source and drain electrodes SD1, SD2 of the thin film transistor TFT comprises a laminated film containing a first electroconductive film and a second electroconductive film, the first electroconductive film being made of a molybdenum-based Mo alloy and the second electroconductive film being made of a silver-based Ag alloy and disposed on the first electroconductive film, can be produced at low cost.

### BACKGROUND OF THE INVENTION

The present invention relates to a liquid crystal display device, more particularly to means for lowering resistance of signal lines and their terminals of the active matrix type liquid crystal display devices in which liquid crystal is driven by thin film transistors (TFT).

The market is expanding for the thin film transistor-driven liquid crystal display devices (TFT-LCD) as an image display device which admits of greater reduction in thickness and weight and higher fineness of display. In such TFT-LCD, two types of signal lines, i.e. scanning lines extending in the x-direction (horizontal direction) and arranged in juxtaposition in the y-direction (vertical direction) and data lines extending in the y-direction and arranged in juxtaposition in the x-direction, are formed on the liquid crystal side of one of the transparent substrates disposed opposing to each other with the interposition of liquid crystal therebetween, and the rectangular areas enclosed by these signal lines constitute the pixel regions.

Each pixel region is provided with a thin film transistor driven by the scanning signal supplied from the scanning lines on one side and a pixel electrode to which the data signal is supplied from the data lines on one side. Each pixel is activated on supply of scanning and data signals. These scanning and data signals are supplied through the terminals of scanning lines and the terminals of data lines, respectively. The terminals of scanning lines and the terminals of data lines extend to the region outside of the display zone formed as an aggregate of pixel regions.

Recently, in line with the tendency toward enlargement of display screen and higher fineness of display of TFT-LCD, the request for lower resistance of signal lines and their terminals has been increasingly intensified. Also, for reducing the production cost, it is required to simplify the production process, to elevate equipment investment efficiency and to raise production yield.

In order to lower resistance of signal lines, it is necessary to use a wiring material with low resistivitiy. Aluminum (Al) and Al-based alloys are well known as such wiring material, but it is necessary to use copper (Cu), silver (Ag), or Cu- or Ag-based alloys as wiring material for attaining further reduction of resistance.

As the signal lines using wiring materials of low resistivity such as copper and silver, those of a “clad structure” in which a low-resistivity wiring material is clad with other metallic material are disclosed in, for instance, JP-A-9-26602. In this clad structure, the low-resistivity wiring material is charged with the role of affording the low resistance characteristics of signal lines while other metallic material serves for providing the contact characteristics with ITO.

However, in order to form such a clad structure, it is usually necessary to carry out the photolitographic operation twice—once for the low-resistivity wiring material and once more for other metallic material—which makes the production process complicated accordingly.

It is strongly desired that the signal lines be formed by one photolithographic operation for simplifying the production process. In this case, for the following reasons, the clad structure becomes a three-layer laminated film structure in which a thin film of silver or copper is sandwiched between the thin films of other metallic material.

First, as a reason why a thin film of other metallic material is required as sublayer of a thin film of silver or copper, the fact is pointed out that copper or silver is weak in adhesive force to the substrate as for instance explained in “Surface Technology” (Hyomen Gijutsu), Vol. 41, p. 485, 1990. That is, it is considered probable that if a thin film of silver or copper is directly formed on a transparent substrate or an insulating film, there would take place film separation to cause a drop of production yield.

Also, in case a thin film of copper or silver is directly formed on the silicon (Si) layer of a thin film transistor as a source or drain electrode, there is a fear of copper or silver being diffused into the silicon layer to lower performance of the thin film transistor TFT.

As another reason for the necessity of a thin film of other metallic material as upper layer of a thin film of silver or copper, it is pointed out that silver or copper has high contact resistance with a transparent electroconductive film such as a film of indium tin oxide (ITO) which is usually used for the pixel electrode and for the terminals of signal lines as for instance explained in “Journal of the Electrochemical Society”, vol. 137, p. 3928, 1990. It is therefore supposed that if a transparent electroconductive film is directly connected to a silver or copper film, there would take place a point or line defect in the display to badly deteriorate the display quality.

For the above reasons, in case the signal lines using silver or copper are formed by one photolithographic operation, there is created a three-layer laminated film structure in which a thin film of silver or copper is sandwiched between the thin films of other metallic material.

However, in order to form a three-layer laminated film by sputtering, there is required a sputtering apparatus furnished with three sputtering targets. Such a sputtering apparatus is expensive and also a long time is required for forming the laminated film, resulting in a reduced throughput rate. This necessitates an increase of the number of sets of sputtering apparatus at the cost of equipment investment efficiency.

### BREIF SUMMARY OF THE INVENTION

The first object of the present invention is to provide a liquid crystal display device which is featured by the fact that the signal lines can be formed with silver or copper by a single photolithographic operation, viz. by a simplified process, with the number of layers of the laminated film structure being confined to 2 or less to reduce the production cost.

As stated in “Corrosion and Anticorrosion Handbook”, pp. 841-858, Japan Society of Corrosion Engineering, Maruzen (2000), silver and copper are the materials which are susceptible to corrosive actions such as migration and feared to induce shorting between the signal lines and other troubles to cause a reduction of production yield.

Accordingly, the second object of the present invention is to provide a liquid crystal display device which is highly proofed against shorting between the signal lines and other troubles by inhibiting the corrosion of the signal lines.

### BRIEF DESCRIPTION OF THE DRAWINGS

FIG. 1 is an equivalent circuit diagram showing the structure of the liquid crystal display device according to Example 1 of the present invention.

FIG. 2 is a plan of a section enclosed by a dotted line a in FIG. 1, showing the structure of one pixel region on a transparent substrate SUB1.

FIG. 3 is the sectional views taken along the line III-III of FIG. 2.

FIGS. 4A and 4B are the schematic illustrations showing the structure of drain terminal DTM.

FIGS. 5A and 5B are the schematic illustrations showing the structure of drain terminal DTM.

FIGS. 6A and 6B are the schematic illustrations showing the structure of gate terminal GTM.

FIGS. 7A and 7B are the schematic illustrations showing the structure of gate terminal portions GTM.

FIG. 8 is a sectional view showing a structure in which the adjacent signal lines or the signal lines differing greatly in potential are disposed in the different layers in Example 1 of the present invention.

FIGS. 9A to 9D are a flow sheet of the step corresponding to the first photolithography.

FIGS. 10A to 10D are a flow sheet of the step corresponding to the second photolithography.

FIGS. 11A to 11D are a flow sheet of the step corresponding to the third photolithography.

FIGS. 12A to 12D are a flow sheet of the step corresponding to the fourth photolithography.

FIGS. 13A to 13D are a flow sheet of the step corresponding to the fifth photolithography.

FIG. 14 is a view showing the whole construction of the liquid crystal display device according to Example 2 of the present invention featuring simplified “chip on glass” (COG) packaging (data transfer system).

FIG. 15 is a sectional view showing a structure in which the adjacent signal lines or the signal lines differing greatly in potential are disposed in the different layers in Example 2 of the present invention.

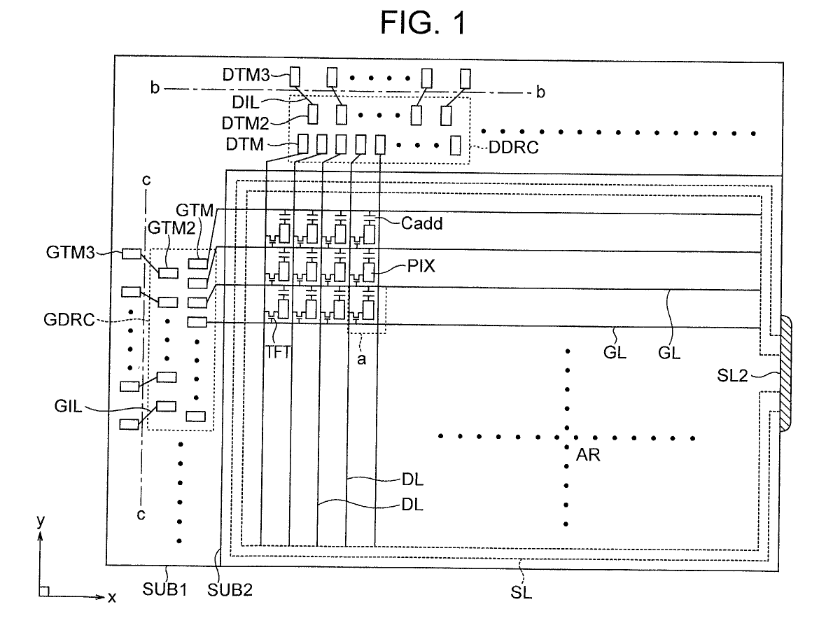

The following reference signs are used in FIGS. 1 through 15:

a: one pixel region

AR: display region

AS: semiconductor layer

BM: black matrix

DBL: bus line

DDRC: semiconductor integrated circuit

DFPC: flexible printed circuit for data signal

DIL: wiring layer

DL: drain (data) line

DTM: drain terminal

DTM2: drain terminal

DTM3: drain terminal

d0: N(+) type semiconductor layer

Cadd: capacitor

CH: contact hole

CT: opposite electrode

ECO: transparent electroconductive film (ITO, IZO or IGO)

ESO: ring-like covering

FIL: color filter

GBL: bus line

GDRC: flexible printed circuit for gate semiconductor integrated circuit

GI: input signal line

GL: gate (scanning) line

GTM: gate terminal

GTM2: gate terminal

GTM3: gate terminal

LC: liquid crystal

OC: planarization layer

OR11: alignment layer

OR12: alignment layer

PFPC: flexible printed circuit for power supply

PIX: pixel electrode

POL1: polarizer

POL2: polarizer

PSV: protective insulating film

SD1: source electrode

SD2: drain electrode

SL: sealant

SL2: sealant

SUB1: one transparent substrate

SUB2: the other transparent substrate

TFT: thin film transistor

x: horizontal direction

y: vertical direction

### DETAILED DESCRIPTION OF THE INVENTION

In order to fulfill the first object, the present invention provides a liquid crystal display device comprising a pair of substrates, a liquid crystal layer sandwiched between said pair of substrates, plural scanning lines formed on one of said substrates, plural data lines crossing said scanning lines in the form of a matrix (hereinafter referred to as matrix-wise), thin film transistors disposed close to the crossing points of said scanning and data lines, and pixel electrodes connected to said thin film transistors, wherein at least one of said scanning line, said data line and the source and drain electrodes of said thin film transistor comprises a laminated film consisting of a first electroconductive film and a second electroconductive film, said first electroconductive film being made of a molybdenum-based alloy, and said second electroconductive film being made of a silver-based alloy and disposed on said first electroconductive film.

The present invention also provides, for attaining the said first object thereof, a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein each of said data lines comprises a laminated film consisting of a first electroconductive film and a second electroconductive film, said first electroconductive film being made of a molybdenum-based alloy and said second electroconductive film being made of a silver-based alloy and disposed on said first electroconductive film.

In order to fulfill the second object, the present invention provides a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, wherein each of said data lines comprises a laminated film consisting of a first electroconductive film and a second electroconductive film, said first electroconductive film being made of a molybdenum-based alloy and said second electroconductive film being made of a silver-based alloy and disposed on said first electroconductive film, and at the terminal of each said data line is formed a contact hole passing through said protective insulating film and said second electroconductive film.

The present invention further provides, for attaining the said second object, a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, wherein each of said data lines comprises a laminated film consisting of a first electroconductive film and a second electroconductive film, said first electroconductive film being made of molybdenum-based alloy and said second electroconductive film being made of a silver-based alloy and disposed on said first electroconductive film, and wherein at the terminal of each said data line is formed a contact hole passing through said protective insulating film and said second electroconductive film, and the first electroconductive film at the bottom of said contact hole is in contact with a transparent electroconductive film.

The transparent electroconductive film is made of indium tin oxide, and it may be designed to cover the first electroconductive film so that it won't be exposed out.

The transparent electroconductive film may be made of either amorphous indium tin oxide, indium zinc oxide or indium germanium oxide, and it may be so designed that the second electroconductive film at the side wall of the contact hole is covered by the transparent electroconductive film so as not to be exposed while at least part of the first electroconductive film at the bottom of the contact hole is not covered by the transparent electroconductive film and is left exposed.

For the fulfillment of said first object, the present invention also provides a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein the source and drain electrodes of each said thin film transistor comprise a laminated film consisting of a first electroconductive film and a second electroconductive film, said first electroconductive film being made of a molybdenum-based alloy and said second electroconductive film being made of a silver-based alloy and disposed on said first electroconductive film.

The present invention further provides, for accomplishing said first object, a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning signal lines almost entirely, and protective insulating films covering said data lines and thin film transistors almost entirely, wherein the source and drain electrodes of each said thin film transistor comprise a laminated film consisting of a first electroconductive film and a second electroconductive film, said first electroconductive film being made of a molybdenum-based alloy and said second electroconductive film being made of a silver-based alloy and disposed on said first electroconductive film, and in each said source electrode is formed a contact hole passing through said protective insulating film and second electroconductive film.

The first electroconductive film at the bottom of each contact hole is in contact with a transparent electroconductive film.

In this case, the transparent electroconductive film may be made of either indium tin oxide, indium zinc oxide or indium germanium oxide, and it may be so designed that the first electroconductive film is covered by the transparent conductive film so as not to be exposed out.

For attaining the first object, the present invention also provides a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein each of said scanning lines comprises a laminated film consisting of a first electroconductive film and a second electroconductive film, said first electroconductive film being made of a molybdenum-based alloy and said second electroconductive film being made of a silver-based alloy and disposed on said first electroconductive film.

For achieving the second object, the present invention further provides a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and thin film transistors almost entirely, wherein each of said scanning lines comprises a laminated film consisting of a first electroconductive film and a second electroconductive film, said first electroconductive film being made of a molybdenum-based alloy and said second electroconductive film being made of a silver-based alloy and disposed on said first electroconductive film, and at the terminal of each said scanning line is formed a contact hole passing through said gate insulating film and second electroconductive film.

The present invention further provides, for attaining the second object thereof, a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning signal lines almost entirely, and protective insulating films covering said scanning lines and thin film transistors almost entirely, wherein each of said scanning lines comprises a laminated film consisting of a first electroconductive film and a second electroconductive film, said first electroconductive film being made of a molybdenum-based alloy and said second electroconductive film being made of a silver-based alloy and disposed on said first electroconductive film, and wherein at the terminal of each said scanning line is formed a contact hole passing through said protective insulating film and second electroconductive film, and the first electroconductive film at the bottom of said contact hole is in contact with a transparent electroconductive film.

The transparent conductive film is made of indium tin oxide and is so designed that the first electroconductive film is covered by said transparent conductive film so as not to be exposed out.

The transparent electroconductive film is made of either amorphous indium tin oxide, indium zinc oxide or indium germanium oxide, and the laminated film structure may be so designed that the second electroconductive film at the side wall of the contact hole is covered by the transparent electroconductive film so as not to be exposed out while at least part of the first electroconductive film at the bottom of the contact hole is not covered by the transparent electroconductive film and is left exposed.

In the above-described embodiments of liquid crystal display device, the data lines and the source and drain electrodes of the thin film transistors comprise a laminated film consisting of a first electroconductive film and a second electroconductive film, said first electroconductive film being made of a molybdenum-based alloy and said second electroconductive film being made of a silver-based alloy and disposed on said first electroconductive film.

Also, in the above-described embodiments, the scanning signal lines, the data lines and the source and drain electrodes of the thin film transistors may comprise a laminated film consisting of a first electroconductive film and a second electroconductive film, said first electroconductive film being made of a molybdenum-based alloy and said second electroconductive film being made of a silver-based alloy and disposed on said first electroconductive film.

Further, in the above embodiments, the first electroconductive film may be made of an alloy having molybdenum as its principal component and also containing at least one element selected from zirconium, hafnium, chromium and titanium.

Preferably the first electroconductive film is made of an alloy having molybdenum as its principal component and containing 4 to 23% by weight of zirconium.

In the above-described embodiments of liquid crystal display device having a protective insulating film, the driver chips may be packaged according to the chip-on-glass (COG) system, and the plural lines connected to the input side of said driver chips may consist of a first line group compose of at least one line and a second line group compose of the lines not belonging to the first line group, said first and second line groups being arranged with the interposition therebetween of at least one of the gate insulating film and the protective insulating film.

The present invention also provides, for accomplishing said second object thereof, a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and thin film transistors almost entirely, in which the driver chips are packaged according to the COG system, wherein the plural lines connected to the input side of the driver chips consist of a first line group compose of at least one line and a second line group composed of the lines not belonging to the first line group, said first and second line groups being arranged with the interposition therebetween of at least one of the gate insulating film and the protective insulating film.

In the above embodiments of the present invention, the problem of film peeling due to weak adhesive force of copper or silver to the sublayer is solved as the first electroconductive film mainly composed of molybdenum is provided below the low-resistance second electroconductive film mainly composed of silver.

Also solved is the problem of reduced performance of thin film transistor due to diffusion of copper or silver into the silicon layer at the source and drain electrodes of the thin film transistor.

It should be further noted that since both of the silver-based alloy and the molybdenum-based alloy can be dissolved in the mixed acid solutions, such as a phosphoric acid/nitric acid/acetic acid mixed solution, patterning can be accomplished by one photolithographic operation and one etching work.

Then the contact holes are formed passing through the insulating films on the scanning lines, the data lines and the source and drain electrodes of thin film transistors, and the second electroconductive films mainly made of silver, and a transparent conductive film is formed above each of these contact holes. This constitution allows direct contact of the transparent electroconductive film with the first electroconductive film mainly made of molybdenum. Since contact resistance between this transparent electroconductive film and the molybdenum-based alloy is low and stabilized, it is possible to lower contact resistance with the transparent electroconductive film even if the molybdenum-based alloy is disposed below the silver-based alloy film.

Here, if a complex process is required for forming the contact holes, it becomes impossible to realize a reduction of production cost aimed at in the present invention.

The present inventors found that in dry etching for forming the contact holes in the insulating films by fluorine plasma, the silver-based alloy undergoes a valence deviation depending on the form of the fluoride, and that this fluoride can be dissolved by a wetting treatment using oxalic acid which does not attack any of the silver-based alloy, molybdenum-based alloy, insulating films and silicon layer.

Thus, the contact holes can be formed by a simple process described above. It is therefore possible to form the signal lines using silver by one photolithographic operation, viz. by a simple process, with the number of the layers of the laminated film being confined to 2 or less to reduce the production cost.

When an alloy mainly composed of molybdenum and containing at least one element selected from zirconium, hafnium, chromium and titanium is used for the first electroconductive film, the film is provided with resistance to dry etching by fluorine plasma and won't be erased during contact hole working. This allows thinning of the first electroconductive film and a reduction of overall thickness of the signal lines, which contributes to a betterment of coverage of the insulating films, the signal lines and transparent electroconductive films, resulting in a substantial rise of production yield.

For control of the sectional shape of signal lines by etching with a phosphoric acid/nitric acid/acetic acid mixed solution, it is best to use a molybdenum-based and zirconium-containing alloy for the first electroconductive film. The zirconium content needs to be 4% by weight or more for securing dry etching resistance, but preferably it does not exceed 23% by weight for inhibiting any etching residue in the etching work using a phosphoric acid/nitric acid/acetic mixed solution. It is more effective for eliminating etching residue to add ammonium fluoride or hydrofluoric acid to the phosphoric acid/nitric acid/acetic acid mixed solution.

The first means for attaining the second object of the present invention is to cover the whole surface of the silver-based alloy layer with an insulating film or a transparent electroconductive film. The scanning line is almost entirely covered in its surface with a gate insulating film and a protective insulating film while the data line and the source and drain electrodes are almost entirely covered in their surfaces with a protective insulating film, so that the area where the silver-based alloy has any possibility of being exposed out on the surface is the inner wall of the contact hole.

So, if the contact holes on the source and drain electrodes, those at the data line terminals and those at the scanning line terminals are covered with a transparent electroconductive film of indium tin oxide, the second electroconductive film made of a silver-based alloy can also be covered. Since connecting resistance of the transparent electroconductive film of indium tin oxide and the anisotropic electroconductive film is low, good terminal connection can be obtained.

However, in case the indium tin oxide is a polycrystalline substance, if an etchant such as hydrobromic acid which is corrodant on the silver-based alloy is used, the etchant of polycrystalline indium tin oxide may penetrate into the faulty parts such as pinholes should they exist in the gate insulating film or protective insulating film on the signal lines to cause corrosion of the signal lines.

In such a case, it is desirable to employ as the transparent electroconductive film material not a polycrystalline but an amorphous indium tin oxide which is capable of being etched with an acid having a weaker corrosive action than the etchant of polycrystalline indium tin oxide.

Use of indium zinc oxide or indium germanium oxide as the transparent electroconductive film material is very advantageous in terms of production yield as it is possible in this case to employ oxalic acid with even lower corrosiveness as the etchant.

It should be noted, however, that if the contact holes at the signal line terminals are covered up perfectly with indium zinc oxide or indium germanium oxide as in the case of the transparent electroconductive film of indium tin oxide, connecting resistance between the transparent electroconductive film surface and the anisotropic electroconductive film elevates, making it unable to effect terminal connection.

This phenomenon is attributable to the lack of zinc in the indium zinc oxide or germanium in the indium germanium oxide in the surface of the transparent electroconductive film. Such a phenomenon is not seen when indium tin oxide is used

So, in case of employing indium zinc oxide or indium germanium oxide as the transparent electroconductive film material, the contact holes at the data line terminals and those at the scanning line terminals are covered only at their side walls with a transparent electroconductive film, and the first electroconductive film mainly composed of molybdenum is exposed at the bottom of the contact holes. In this case, terminal connection is established between the first electroconductive film mainly composed of molybdenum and the anisotropic electroconductive film. Good terminal connection is ensured because of low connecting resistance between the molybdenum-based alloy and the anisotropic electroconductive film. This arrangement also allows covering of the second electroconductive film mainly composed of silver.

The second means for attaining the second object of the present invention is to arrange the adjacent signal lines or the signal lines differing greatly in potential in the different layers.

More specifically, in a liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, in which the driver chips are packaged according to the COG system, a structure is employed in which of the input signal lines of the semiconductor integrated circuits, those adjacent to each other are disposed in the different layers. Also, in a simple COG packaged (data transfer system) liquid crystal display device in which the driving power sources of display data and semiconductor integration circuits are electrically connected between the semiconductor integrated circuits by bus lines, a structure is employed in which of the bus lines, those adjacent to each other are disposed in the different layers. In these structures, the space between the adjoining signal lines is enlarged in the same layer, so that the probability of occurrence of shorting trouble between the signal lines due to migration or other causes is greatly lessened. Also, an allowance is provided for the layout of signal lines, which proves advantageous in designing for realizing a liquid crystal display device of high fineness of display and small pixel pitch.

The second means for achieving the second object may not necessarily be incorporated in the present invention. It is evident that this second means for attaining the second object is also effective in a liquid crystal display device comprising a laminated film consisting of a first electroconductive film and a second electroconductive film, said first electroconductive film being made of a molybdenum-based alloy and said second electroconductive film being made of a silver-based alloy and disposed on said first electroconductive film, in which the signal lines made of a silver-based alloy are not used as the scanning or data lines.

By incorporating the above-described means, it is possible to provide a liquid crystal display device which is highly proofed against corrosion of signal lines and against shorting between the signal lines and other troubles.

The present invention has been described above concerning a liquid crystal display device of the so-called vertical field type liquid crystal drive system as an exemplification of the invention, but it is obvious that the present invention can as well be applied to the liquid crystal display devices of the in-plane switching type liquid crystal drive system.

Now, the embodiments of liquid crystal display device according to the present invention are described with reference to FIGS. 1 to 15 of the accompanying drawings.

### EXAMPLE 1

<<Equivalent Circuits>>

FIG. 1 is an equivalent circuit diagram showing the layout of the liquid crystal display device according to Example 1 of the present invention. This circuit diagram is drawn in conformity to the actual geometrical arrangement.

In the embodiment (Example 1) shown in FIG. 1, a pair of transparent substrates SUB1 and SUB2 are disposed opposing to each other with a liquid crystal layer sandwiched therebetween.

On the liquid crystal side of the transparent substrate SUB1 are formed gate (scanning) lines GL extending in the x-direction and arranged in juxtaposition in the y-direction and drain (data) lines DL extending in the y-direction while being insulated from the gate lines GL and arranged in juxtaposition in the x-direction. The rectangular areas encompassed by these gate (scanning) lines DL and drain (data) lines DL serve as the pixel regions, and an aggregate of these pixel regions constitutes an display region AR.

In each of the pixel regions are disposed a thin film transistor TFT driven by the scanning signal (voltage) from one of the gate lines GL and a pixel electrode PIX to which the data signal (voltage) is supplied from a drain line DL via the said thin film transistor TFT.

When the size of the liquid crystal display device is enlarged, the signal lines are elongated correspondingly to increase resistance of the gate and drain lines GL and DL. Also, as the fineness of display of the liquid crystal display device enhances, the signal line width becomes smaller, causing a corresponding increase of resistance of the gate and drain lines GL and DL. A rise of resistance of these lines GL and DL leads to a drop of voltage of the scanning and data signals, making it unable to supply sufficient signal voltage to the thin film transistors TFT, which results in serious degradation of image qualities such as luminance gradient.

A capacity element Cadd is disposed between the pixel electrode PIX and a gate line GL adjacent to another gate line. This capacity element Cadd functions to store for a long time the data signal supplied to the pixel electrode PIX when the thin film transistor TFT goes off.

The pixel electrode PIX in each pixel region generates an electric field between it and its opposite electrode CT (not shown) provided in common to the respective pixel regions on the liquid crystal side of the transparent substrate SUB2 disposed vis-a-vis to the substrate SUB1 with a liquid crystal layer interposed therebetween, thereby controlling light transmittance of the liquid crystal between the adjoining electrodes.

One end of each of the gate lines GL extends to an edge (on the left side of the drawing) of the transparent substrate SUB1. At the extension of each gate line GL is formed the terminal GT connected to the bump of a semiconductor integrated circuit GDR of the vertical scanning circuitry provided on the transparent substrate SUB1.

An end of each drain line DL extends to an edge (on the upper side of the drawing) of the transparent substrate SUB1, and at the extension of this drain line DL is formed the terminal DTM connected to the bump of a semiconductor integrated circuit DDR of the data signal drive circuitry provided on the transparent substrate SUB1.

The semiconductor integrated circuits GDRC, DDRC are themselves perfectly packaged on the transparent substrate SUB1 according to the so-called COG system.

The bumps on the input side of the semiconductor integrated circuits GDRC, DDRC are also connected to the terminals GTM2, DTM2, respectively, formed on the transparent substrate SUB1. These terminals GTM2, DTM2 are connected to the corresponding terminals GTM3, DTM3 disposed at the peripheral portion of the substrate SUB1 closest to the end face via the respective wiring layers GIL, DIL.

In this COG system, the bumps on both input and output sides of the semiconductor integrated circuits GDRC, DDRC are arranged to have a very small spacing from the adjoining ones, so that the terminals GTM of the gate lines GL and the terminals DTM of the drain lines DL are also arranged to be spaced very narrowly from the adjoining ones.

Therefore, the areas occupied by the respective bumps of the semiconductor integrated circuits GDRC, DDRC at the terminals GTM, DTM of the gate and drain lines GL, DL are very small, and the increase of connection resistance between the bumps and the terminals GTM, DTM is unignorably large. Also, this arrangement tends to cause shorting between the adjoining terminals.

Transparent substrate SUB2 is disposed vis-a-vis to SUB1 in such a way as to keep away from the region where the semiconductor integrated circuits are mounted, and is smaller in area than SUB1.

Transparent substrate SUB2 is secured to SUB1 by a sealant SL applied to the periphery of SUB2. This sealant SL also serves for sealing the liquid crystal between the two substrates SUB1 and SUB2.

While the embodiments of liquid crystal display device employing the COG system have been described, the present invention can as well be applied to the liquid crystal display devices of the tape carrier package (TCP) system. This TCP system is a package system according to which a pattern is formed by photolithography on a flexible table to provide a tape carrier, and the semiconductor integrated circuit chips are packaged on this tape carrier by the tape automated bonding (TAB) technique. The output terminals of the package are connected to the corresponding terminals formed on SUB1 while the input terminals are connected to the corresponding terminals on a printed substrate disposed close to SUB1.

<<Pixel Structure>>

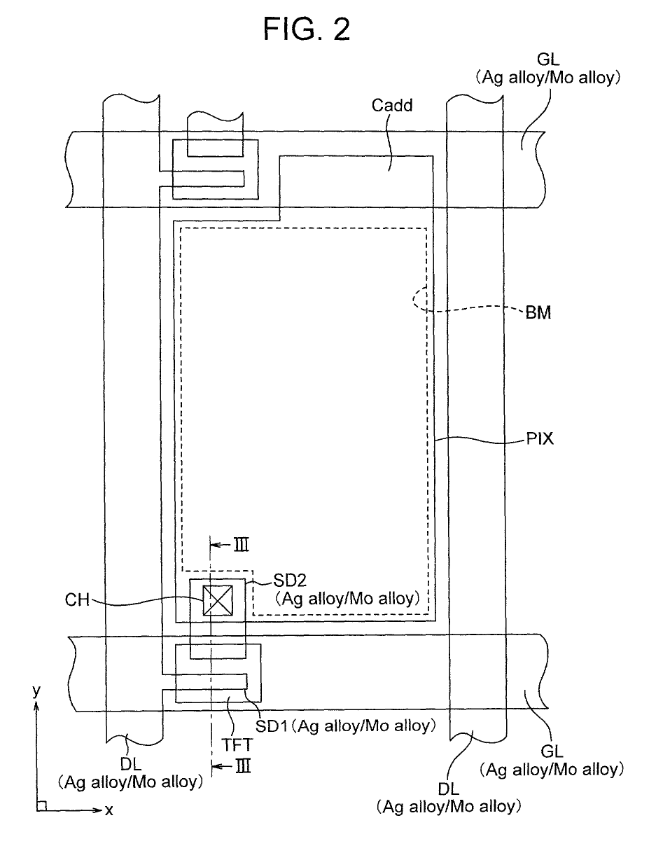

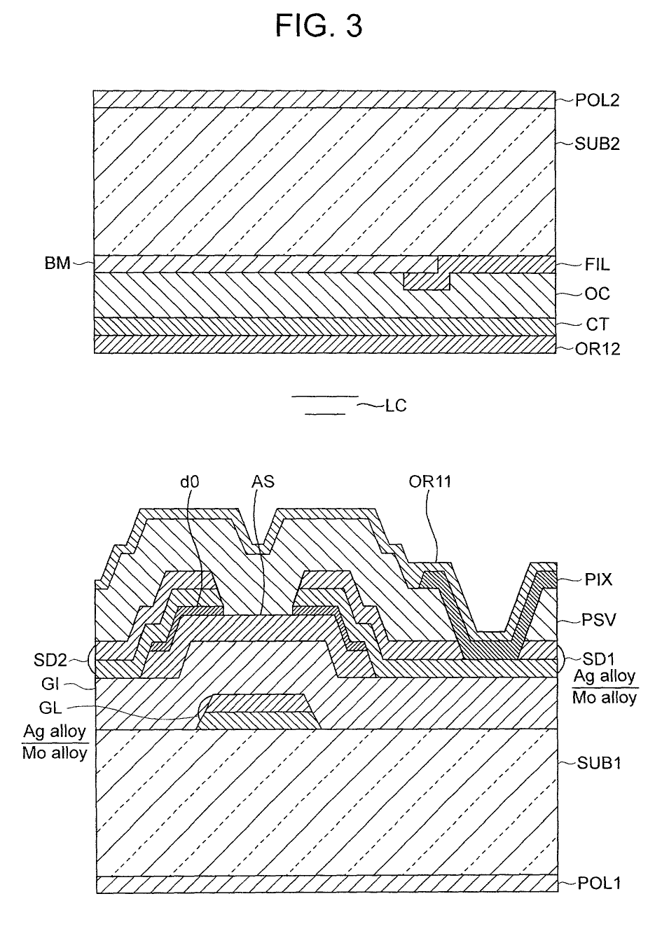

FIG. 2 is a plan showing the structure of one pixel region on the transparent substrate SUB1, which corresponds to the portion enclosed by a dotted line a in FIG. 1. FIG. 3 is the sectional views taken along the line III-III of FIG. 2.

As is seen in FIG. 2, the gate lines GL extending in the x-direction and arranged in juxtaposition in the y-direction are formed on the liquid crystal side of the transparent substrate SUB1.

In Example 1, each of the gate lines GL is of a double layer structure, with the lower layer being composed of a Mo-based alloy and the upper layer of an Ag alloy. In the following descriptions, “Mo-based alloy” (alloy principally composed of Mo) is referred to simply as Mo alloy.

Use of an Ag alloy for the upper layer is purposed to lower resistance of the gate lines GL. An Mo alloy was used for the lower layer for the purpose of reducing contact resistance with the gate terminals GTM, GTM2, GTM3. Their effects will become apparent from the explanation given later.

On the surface of the transparent substrate SUB1 is formed an insulating film GI made of, for instance, SiN, enshrouding the gate lines GL. This insulating film GI functions as an interlaminar insulating film, in relation to the gate lines GL, for the drain lines DL described later, as a gate insulating film for the thin film transistors also described later, and as a dielectric film for the capacity element Cadd described later.

At the lower left portion of the pixel region where it overlaps the gate lines GL, there is formed an i-type (intrinsic) semiconductor layer AS made of, for instance, a-Si. This semiconductor layer AS, along with the source and drain electrodes formed thereabove, functions as a semiconductor layer for the MIS type thin film transistors TFT in which part of the gate lines GL serve as gate electrode.

The source electrodes SD1 and the drain electrodes SD2 of the thin film transistors TFT are formed simultaneously with the drain lines DL formed on the insulating film GI. That is, in FIG. 2, when part of the drain lines DL extending in the y-direction and arranged in the x-direction are formed reaching the upper side of the semiconductor layer AS, their extensions become the drain electrodes SD2 of the thin film transistors TFT, and the electrodes formed spaced apart from these drain electrodes SD2 become the source electrodes SD1. Since these source electrodes SD1 are connected to the corresponding pixel electrodes PIX described later, they have slight extensions toward the center of the pixel region for secure connection.

In the instant embodiment of the present invention, each drain line DL is of a two layer structure, with the lower layer being composed of an Mo alloy and the upper layer of an Ag alloy.

Use of an Ag alloy for the upper layer is intended to lower resistance of the drain lines DL. An Mo alloy is used for the lower layer to reduce contact resistance with the drain terminals DTM, DTM2 and DTM3. Their effects will become apparent from the explanation given later.

At the interface between the drain and source electrodes SD2, SD1 and the semiconductor layer AS is formed a semiconductor layer doped with impurities. This semiconductor layer functions as a contact layer. After the semiconductor layer AS has been formed, an impurity-doped thin semiconductor layer is formed on its surface, and after the drain and source electrodes SD2, SD1 have been formed, the portion of the semiconductor layer exposed out from each electrode as the mask is etched to provide the above-described structure.

On the surface of the transparent substrate SUB1 having the drain lines DL (drain electrodes SD2 and source electrodes SD1) formed on its surface in the manner described above, there are formed the protective insulating films PSV made of, for instance, SiN, covering the drain lines DL, etc. These protective insulating films PSV are provided, for one thing, for avoiding direct contact with the liquid crystal of the thin film transistors TFT.

In each protective insulating film PSV is formed a contact hole CH by fluorine plasma dry etching for the purpose of exposing and connecting part of the extension of each source electrode SD1 of thin film transistor TFT to a corresponding pixel electrode explained later. By this operation, the Ag alloy composing the source electrode SD1 vanishes away and the Mo alloy is exposed out at the bottom of the contact hole CH.

On the upper side of the protective insulating film PSV is formed a transparent pixel electrode PIX covering the best part of the pixel region, said pixel electrode PIX comprising an indium-tin-oxide (ITO) film, an indium-zinc-oxide (IZO) film or an indium-germanium-oxide (IGO) film. This pixel electrode PIX is also so formed as to cover the contact hole CH in each protective film PSV and is connected to the Mo alloy of the source electrode SD1 of the thin film transistor TFT. Because of low contact resistance between ITO, IZO or IGO and the Mo alloy, a good electrical connection can be established. If the silver alloy overlying the Mo alloy does not vanish away, there is resultantly formed an ITO, IZO or IGO and Ag alloy contact structure which deteriorates the electrical connection.

On the surface of the transparent substrate SUB1 having the pixel electrodes PIX formed thereon as described above, there is further formed an alignment layer OR11 which covers the pixel electrodes PIX, too. This alignment layer OR11 is composed of, for instance, a resin, with its surface having been subjected to a rubbing treatment in a specified direction. Said alignment layer OR11 is brought into contact with the liquid crystal LC to determine the direction of initial orientation of the liquid crystal LC.

On the side opposite from the liquid crystal LC of the transparent substrate SUB1 is disposed a polarizer POL1.

On the other hand, on the liquid crystal side of the transparent substrate SUB2 are formed black matrices BM so as to define the respective pixel regions. These black matrices BM are provided for shutting off external light from the thin film transistors and for bettering display contrast.

Further, in said black matrices BM, color filters FIL having the colors corresponding to the respective pixel regions are provided in the openings where light is transmitted and which become the substantial pixel regions. As such color filters FIL, there are used, for instance, those of the same color for the pixel regions disposed in juxtaposition in the y-direction, and for instance the filters of red (R), green (G) and blue (B) are arranged in that order repetitively for every pixel region in the x-direction.

On the surface of the transparent substrate SUB2 having said black matrices BM and color filters FIL provided thereon in the manner described above, there is formed a resin-made planarization layer OC formed by coating or other means so as to cover said black matrices BM, etc., whereby to inhibit any level difference from being created on the substrate surface by said black matrices BM and color filters FIL.

On the surface of said planarization layer OC are formed opposite electrodes CT which are common to the respective pixel regions and made of, for instance, ITO. These opposite electrodes CT function to generate an electric field corresponding to the data signal (voltage) between CT and the pixel electrodes PIX in the respective pixel regions to control the direction of orientation of the liquid crystal LC between these electrodes. They also control light transmittance with a suitable combination of the above-described polarizer POL1 and another polarizer POL2 to be described later.

On the surface of the transparent substrate SUB2 having the opposite electrodes CT provided thereon as described above, there is further formed an alignment layer OR12 covering said opposite electrodes CT. This alignment layer OR12 is made of, for instance, a resin, with its surface having been subjected to rubbing in a specified direction. Alignment layer OR12 is brought into contact with liquid crystal LC to determine the direction of its initial orientation.

On the side opposite from liquid crystal LC of transparent substrate SUB1 is mounted another polarizer POL2.

<<Structure of Terminals>>

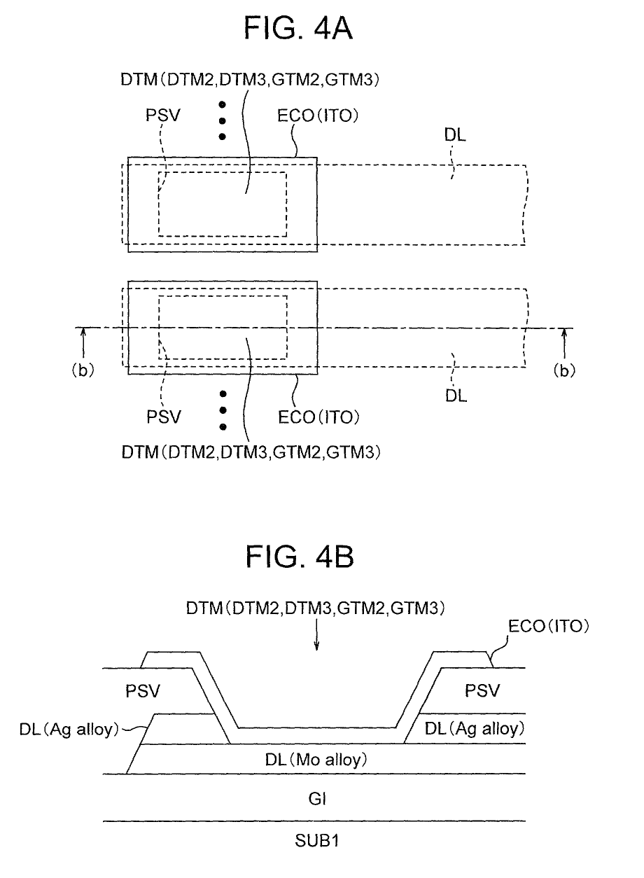

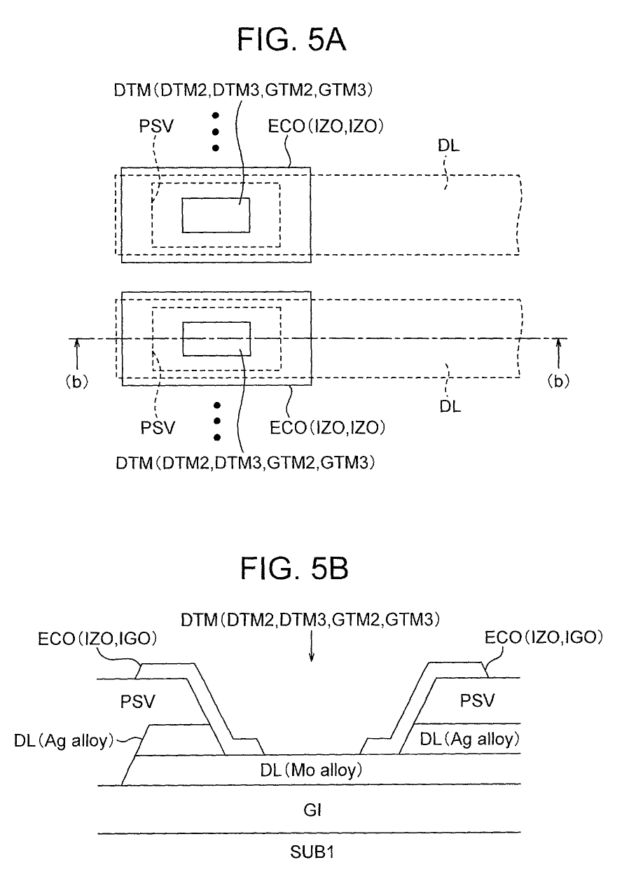

FIGS. 4A and 4B and FIGS. 5A and 5B are the schematic illustrations of the structures of the drain terminals DTM. FIG. 4A and FIG. 5A are the plans showing two of a plurality of drain terminals DTM arranged in juxtaposition to each other, and FIG. 4B and FIG. 5B are the sectional views taken along the line b-b of FIGS. 4A and 5A.

On the surface of transparent substrate SUB1 are formed drain lines DL extending from display section AR. Each drain line DL comprises a laminated film consisting of a first electroconductive film and a second electroconductive film, said first electroconductive film being made of an Mo alloy and the second electroconductive film being made of an Ag alloy and disposed on said first electroconductive film.

Each drain line DL is initially in a state of being covered by a protective insulating film PSV, but when a contact hole is formed at the terminal by fluorine type dry etching gas, the Ag alloy on the drain line DL is transformed into a fluoride. Since this fluoride is soluble in an acid solution such as an aqueous solution of oxalic acid, the Mo alloy below the drain line DL is exposed out when a wetting treatment is carried out.

By the above simple process, it is possible to remove from the bottom of the contact hole the Ag alloy which is susceptible to corrosion and is high in connection resistance with transparent conductive film ECO of ITO, IZO or IGO and also with anisotropic electroconductive film ACF. This makes it possible to expose the Mo alloy which is less liable to corrosion than silver and is low in connection resistance with transparent conductive film ECO of ITO, IZO or IGO and also with anisotropic electroconductive film ACF.

Here, as shown in FIGS. 4A and 4B, each contact hole is coated with ITO. In this way, both the Mo alloy exposed at the bottom of the contact hole and the Ag alloy having bad corrosion resistance and exposed at the inner periphery of the contact hole can be coated with a highly anticorrosive oxide. Since ITO is very low in contact resistance with anisotropic electroconductive film ACF, good terminal characteristics can be obtained.

In case ITO is polycrystalline (polycrystalline ITO, hereinafter abbreviated as pITO), its etching solution is comprised of a very strong acid such hydrobromic acid. Therefore, if a flaw such as pinhole exists in the protective insulating film PSV on the drain line DL, the strong etching solution may penetrate through such a flaw to corrode the drain line DL, which can even result in a break or disconnection of the line.

In such a case, it is suggested to use amorphous ITO (hereinafter abbreviated as aITO). Since its etching solution is weaker than the etching solution of pITO, the probability of break or disconnection of the drain line DL due to corrosion thereof can be lessened.

The contact hole may be coated only at its inner periphery with IZO or IGO as shown in FIGS. 5A and 5B. In this way, the Ag alloy with poor corrosion resistance, which is exposed at the inner periphery of the contact hole, can be covered with an oxide with high corrosion resistance. It should be noted, however, that since IZO or IGO tends to lack in zinc or germanium in its surface to cause a rise of surface resistance, contact resistance with the anisotropic electroconductive film ACF on this surface is unsatisfactory.

So, in case of using IZO or IGO, the Mo alloy at the bottom of the contact hole is left uncovered and connected to the anisotropic electroconductive film ACF. Connection resistance of this terminal is sufficiently low, but it is undeniable that this terminal is inferior in long-term reliability to the terminal which has its contact hole covered up completely with ITO.

However, if the production is carried out by properly selecting the anisotropic electroconductive film ACF and paying sufficient care so as not to allow inclusion of salinity, it is possible to obtain reliability of the level acceptable for practical use.

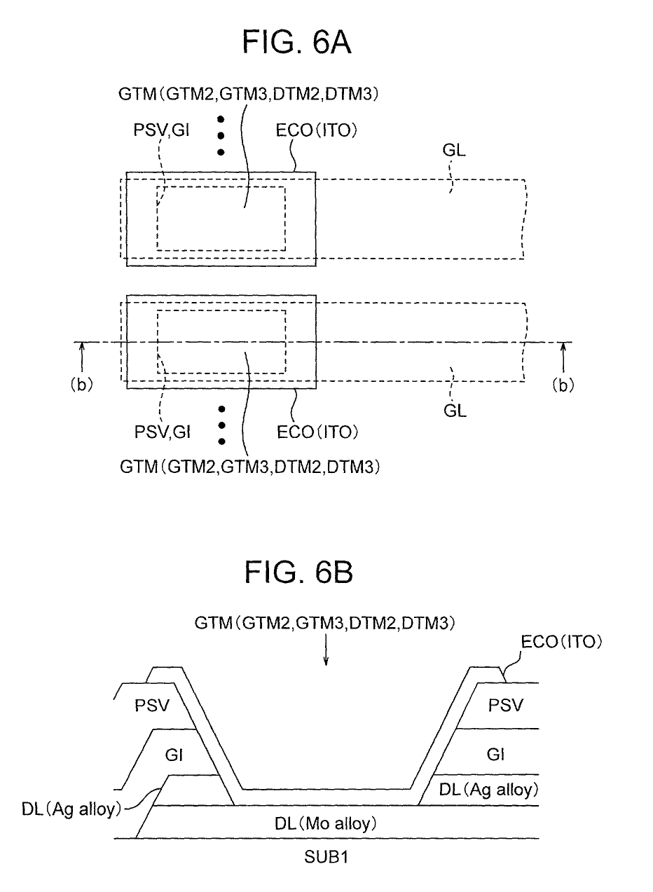

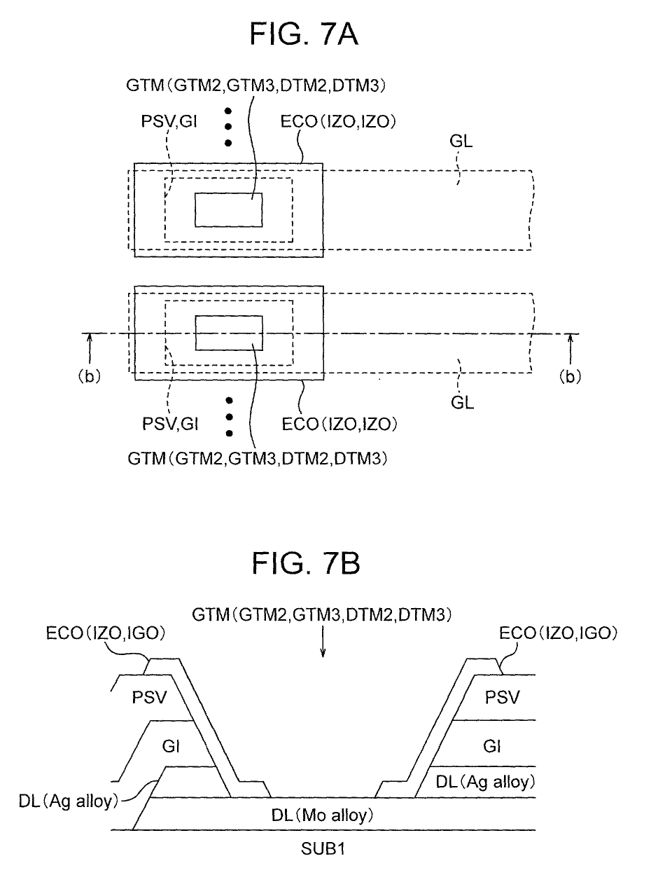

As shown in FIGS. 6A and 6B and FIGS. 7A and 7B, gate terminals GTM can be designed substantially similarly to drain terminals DTM shown in FIGS. 4A and 4B and FIGS. 5A and 5B. This terminal structure can be applied to the terminals DTM2, DTM3, GTM2, GTM3 on the input side of the semiconductor integrated circuit. When signal lines DIL, GIL on the input side of the semiconductor integrated circuit are formed in the same layer as drain lines DL, terminals DTM2, DTM3, GTM2, GTM3 on the input side of the semiconductor integrated circuit have the structure shown in FIGS. 4A and 4B and FIGS. 5A and 5B.

When signal lines DIL, GIL on the input side of the semiconductor integrated circuit are formed in the same layer as gate lines GL, terminals DTM2, DTM3, GTM2, GTM3 on the input side of the semiconductor integrated circuit have the structure shown in FIGS. 6A and 6B and FIGS. 7A and 7B.

<<Structure of Signal Lines on Input Side of Semiconductor Integrated Circuit>>

The above-described construction of the contact holes at the terminals was instrumental in realizing a liquid crystal display device in which the Ag alloy, which, though low in resistance, is susceptible to the corrosive actions such as migration, is not exposed out.

However, it is desirable to elevate resistance to shorting at the area where the spacing between the signal lines formed in the same layer is narrow.

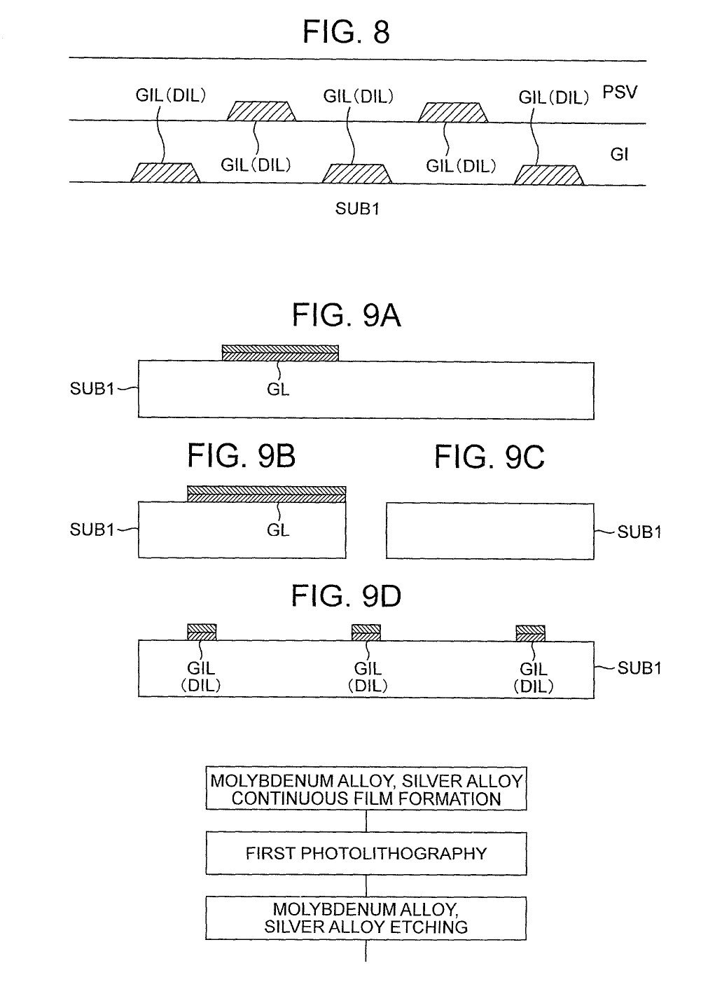

For this purpose, it is effective to dispose the adjacent signal lines or the signal lines differing greatly in potential in the different layers as shown in FIG. 8. FIG. 8 is a sectional illustration of the structure in which the adjoining ones of the input signal lines GIL, DIL of semiconductor integrated circuits GDRC, DDRC are disposed in the different layers, in the liquid crystal display device using the COG packaging system shown in FIG. 2. The structure of FIG. 8 allows wide spacing between the adjoining signal lines in the same layer to greatly reduce shorting troubles between the signal lines due to migration and other causes. Also, since a greater allowance is provided for the signal line layout, a great advantage is given to designing in producing a liquid crystal display device of high fineness of display and small pixel pitch.

The structure of FIG. 8 may not necessarily be employed in the present invention. It is obvious that the structure of FIG. 8 is also effective in a liquid crystal display device not employing the signal line constitution in which the scanning or data lines comprise a laminated film consisting of a first electroconductive film and a second electroconductive film, said first electroconductive film being made of a molybdenum-based alloy and said second electroconductive film being made of a silver-based alloy and disposed on the first electroconductive layer.

<<Production Process>>

A process for producing the transparent substrate SUB1 side portion of the liquid crystal display device in the instant embodiment (Example 1) of the present invention is here described with reference to FIGS. 9A-9D through FIGS. 13A-13D. FIGS. 9A to 9D show the sectional shapes of the signal lines, with 9A showing a signal line at the thin film transistor TFT section, 9B a signal line at the gate terminal GTRM, 9C a signal line at the drain terminal DTM, and 9D plural signal lines on the input side of the semiconductor integrated circuit GDRC or DDRC.

The process described here concerns the case where the photolithographic operation was conducted five times. FIGS. 9A-9D to FIGS. 13A-13D correspond to the respective photolithographic operations and show the sectional shapes of the structure at the stage where the photoresist was removed. The “photolithographic operation” referred to herein means a series of works comprising application of photoresist on the substrate, selective exposure through a mask, and development.

It will be understood that the structure of the liquid crystal display device according to the present invention is not subject to limitation by the process described below.

FIGS. 9A to 9D show the step corresponding to the first photolithographic operation in the production process.

On an electrically insulating transparent substrate SUB1 are formed a 40 nm thick Mo—Zr alloy layer and thereon a 160 nm thick Ag—Pd alloy, both by sputtering. Then a photoresist pattern is formed by photolithography, and the laminated film of Mo—Zr alloy and Ag—Pd alloy (hereinafter referred to as Ag—Pd alloy/Mo—Zr alloy laminated film) is etched en masse with an etching solution composed of phosphoric acid, nitric acid, acetic acid, ammonium fluoride, water, etc., to form the gate signal lines GL and the signal lines GIL, DIL on the input side of the semiconductor integrated circuits GDRC, DDRC.

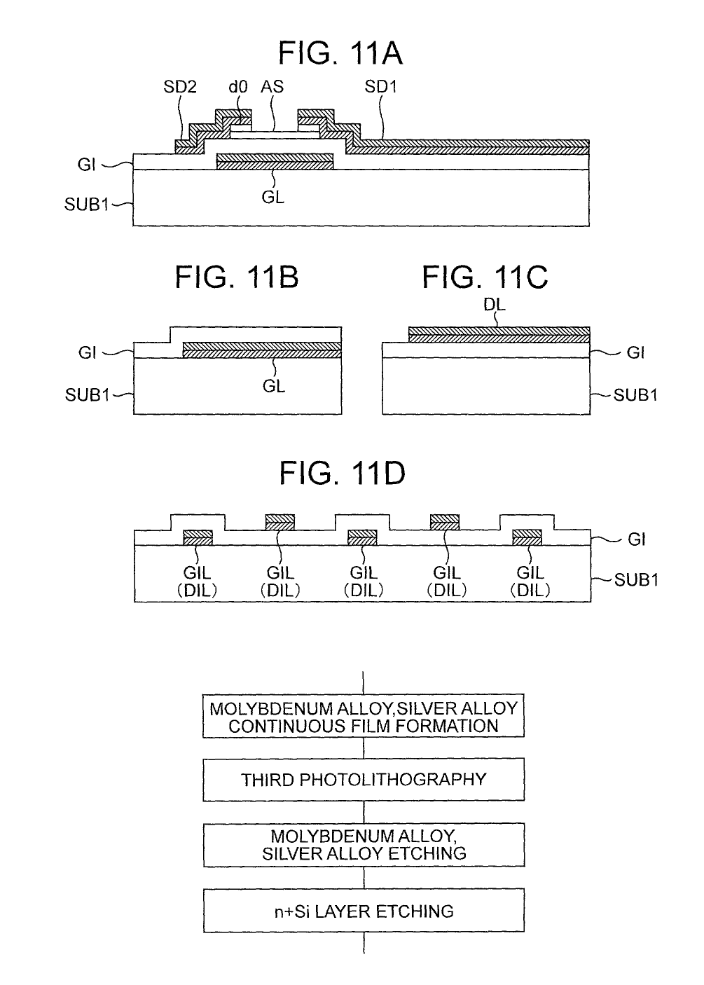

Mo—Zr alloy is used for the lower layer (Mo alloy layer) to provide resistance to dry etching by fluorine plasma in the fourth photolithographic operation (FIGS. 11A-11D) to be described later so that the Mo alloy layer won't be erased by drying etching. Such resistance to dry etching by fluorine plasma can be obtained as well by using Mo—Cr alloy, Mo—Hf alloy or Mo—Ti alloy instead of Mo—Zr alloy.

Employment of these Mo alloys allows thinning of the Mo alloy layer, making it possible to reduce the overall thickness of the Ag alloy/Mo alloy laminated film. This contributes to the betterment of coverage of the gate insulating film to be described later and a remarkable improvement of the drain signal lines or transparent conductive film to be discussed later, realizing a notable enhancement of production yield.

Of the said four types of Mo alloy, Mo—Zr alloy is the best for controlling the sectional shape of the etched Ag alloy/Mo alloy laminated film. Zr content in Mo—Zr alloy is preferably 4% by weight or more for securing dry etch resistance but not more than 23% by weight for not allowing etching residue in the etching operation using a phosphoric acid/nitric acid/acetic acid mixed solution.

Use of Ag—Pd alloy for the upper layer (Ag alloy layer) is envisioned to improve corrosion resistance of the Ag alloy. It should be noted that a too high Pd content in said alloy invites a rise of electric resistivity of the Ag alloy to make it unable to fulfill the intended object of the present invention. The Ag—Pd alloy in the instant embodiment contained about 1% by weight of Pd.

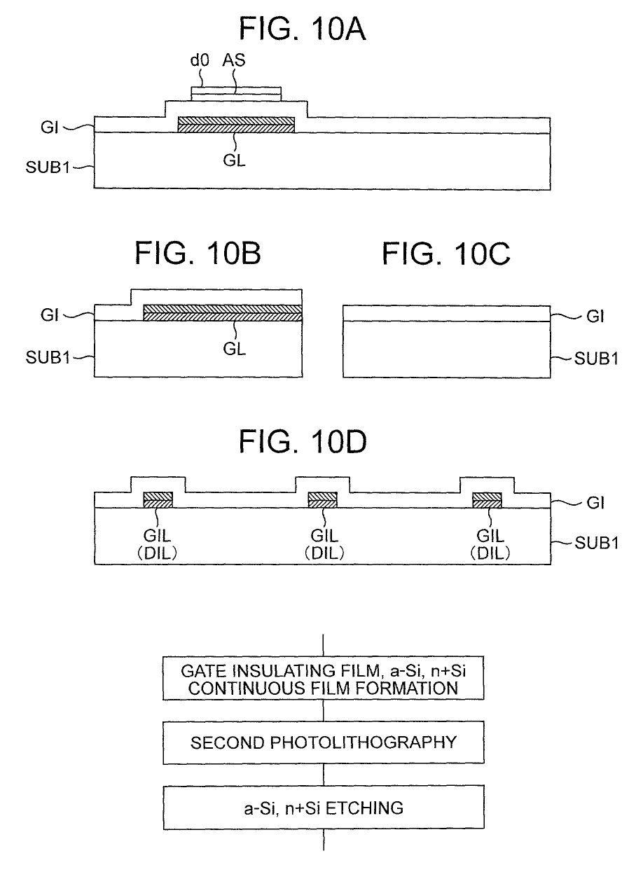

FIGS. 10A to 10D show the step corresponding to the second photolithographic operation.

Ammonia gas, silane gas and nitrogen gas are introduced into a plasma CVD system to form a 350 nm thick SiN film as well as a gate insulating film GI. Then silane gas and hydrogen gas are introduced into the plasma CVD system to form a 200 nm thick i-type amorphous Si film, followed by further introduction of hydrogen gas and phosphine gas to form a 20 nm thick N(+) type amorphous Si film. Thereafter, a photoresist pattern is formed by photolithography and then the N(+) type amorphous Si film and i type amorphous Si film are etched by using SF₆ as dry etching gas to form an insular i type semiconductor layer AS near the thin film transistor TFT.

FIGS. 11A to 11D show the step corresponding to the third photolithographic operation.

A 40 nm thick Mo—Zr alloy layer and in succession a 100 nm thick Ag—Pd alloy are formed both by sputtering. Then, after forming a photoresist pattern by photolithography, the Ag—Pd alloy/Mo—Zr alloy laminated film is etched en masse with an etching solution composed of phosphoric acid, nitric acid, acetic acid, ammonium fluoride, water, etc., to form the drain lines DL, source electrodes SD1, drain electrodes SD2, and signal lines GIL, DIL on the input side of the semiconductor integrated circuits GDRC, DDRC. Then SF₆ gas is introduced into the drying etching apparatus to selectively remove the N(+) type semiconductor layer d0 in order to insulate source electrode SD1 and drain electrode SD2 to form a channel.

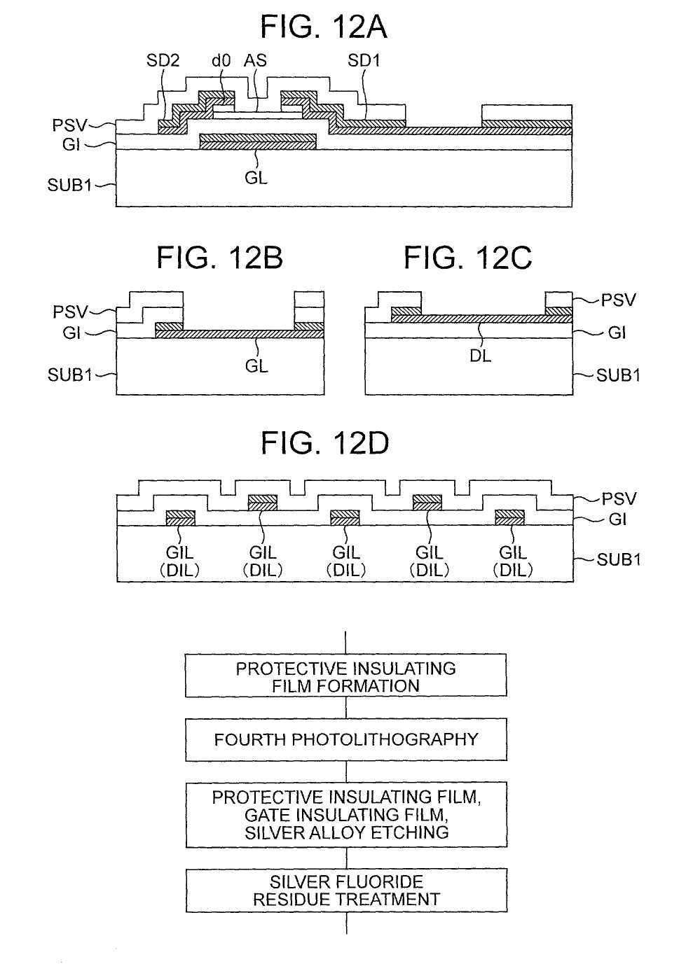

FIGS. 12A to 12D show the step corresponding to the fourth photolitographic operation.

Ammonia gas, silane gas and nitrogen gas are introduced into a plasma CVD system to form 350 nm thick SiN films and protective insulating films PSV. A photoresist pattern is formed by photolithography, and then by using SF₆ as dry etching gas, contact holes are formed in the gate insulating films GI and protective insulating films PSV on the source electrode SD1, gate terminal GTM, drain terminal DTM, and terminals GTM2, GTM3, DTM2, DTM3 of signal lines GIL, DIL on the input side of semiconductor integrated circuits GDRC, DDRC. (Contact holes on GTM2, GTM3, DTM2 and DTM3 are not shown.) By this dry etching, Ag alloy at the bottom of each contact hole is transformed into silver fluoride. Then silver fluoride at the bottom of each contact hole is selectively dissolved away with oxalic acid.

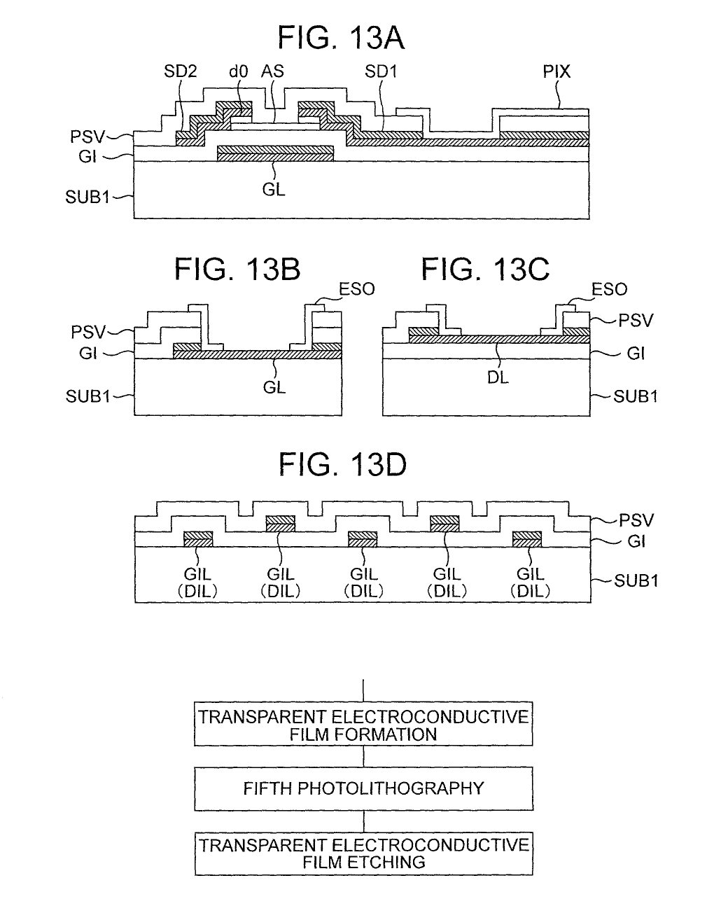

FIGS. 13A to 13D show the step corresponding to the fifth photolitographic operation.

A transparent electroconductive film comprising a 115 nm thick IZO film is formed by sputtering. Then a photoresist pattern is formed by photolithography, followed by etching with an aqueous solution principally composed of oxalic acid to form pixel electrodes PIX, and the peripheries of the contact holes at the gate terminals GTM, drain terminals DTM, and terminals GTM2, GTM3, DTM2, DTM3 on the input side of semiconductor integrated circuits GDRC, DDRC are covered in the form of a ring (ECO).

Use of an aqueous solution of oxalic acid as etching solution allows working of IZO without inflicting damage to Ag alloy used for the signal lines, so that the production yield won't be decreased even if there exist pinholes or other flaws in the protective films PSV, etc.

### EXAMPLE 2

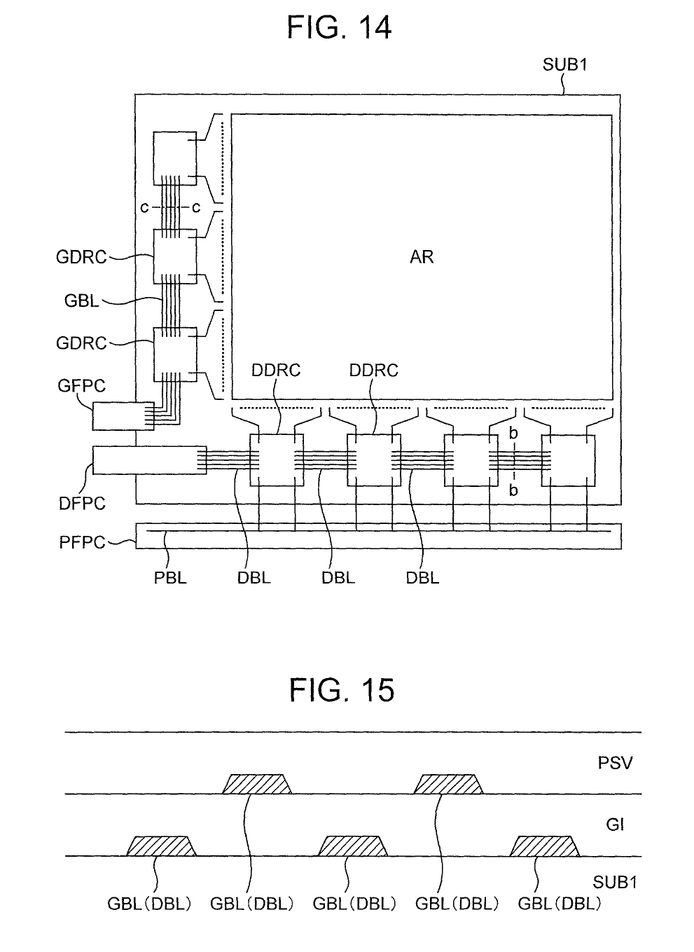

FIG. 14 is a general structural illustration of the liquid crystal display device according to Example 2 of the present invention incorporating a simple COG packaging system (data transfer system) in which display data and the power sources for semiconductor integrated circuits GDRC are electrically connected between the semiconductor integrated circuits GDRC, DDRC by bus lines GBL, DBL formed on substrate SUB1.

In the construction of FIG. 14, the scanning signals supplied from flexible printed circuits GFPC for gate semiconductor integrated circuits and the power source voltage for gate semiconductor integrated circuits GDRC are led to gate semiconductor integrated circuits GDRC via gate power bus lines and scanning signal bus lines GBL. With the data transferred successively to the adjoining gate semiconductor integrated circuits GDRC, scanning signals are written in each gate semiconductor integrated circuit GDRC.

Because of large load on the drain line side of the package, the power source voltage for drain semiconductor integrated circuits DDRC is supplied from flexible printed circuits PFPC for power supply via power bus lines PBL. With data transferred successively to the adjoining drain semiconductor integrated circuits DDRC, data signals are written in these circuits DDRC.

Also, on gate side, because of large load on the driving power lines in comparison with the signal lines, there may be provided the flexible printed circuits similar to the flexible printed circuits PFPC for power supply provided on the drain side. In this case, too, since the number of the signal lines is lessened as compared with the conventional system, it is possible to reduce the flexible printed circuit width to realize a cost reduction.

The above-described data transfer system can be actualized by lowering contact resistance between the bumps BUP of semiconductor integrated circuits GDRC, DDRC and the corresponding terminals GTM, GTM2, GRM3, DTM, DTM2, DTM3, and also reducing resistance of the bus lines GBL, DBL.

In Example 2, low contact resistance was attained by using a low-resistance Ag alloy/Mo alloy film and by employing a terminal (GTM, DTM, GTM2, GTM3, DTM2, DTM3) structure which allows direct contact between Mo alloy or ITO and ACF, and this helped realize the so-called data transfer system.

When this system is employed, it is possible to dispense with the gate side flexible printed circuits FPC and to minimize the width of the drain side flexible printed circuits FPC, which conduces to a remarkable enhancement of connection reliability and allows narrowing of the display frame. Further, as a result of reduction in size of the flexible printed circuits FPC, their production cost can be curtailed.

Because of small spacing between the bus lines GBL, DBL in the data transfer system, it is desirable to elevate resistance against shorting between the signal lines. For this purpose, it is expedient to dispose the adjacent bus lines or the bus lines differing greatly in potential in the different layers as shown in FIG. 15. FIG. 15 is a sectional illustration of the structure in which the adjacent bus lines GBL, DBL are disposed in the different layers in a liquid crystal display device adopting the data transfer system shown in FIG. 14. According to the structure shown in FIG. 15, since spacing between the adjoining signal lines in a same layer is widened, it is possible to greatly lessen the probability of shorting between the signal lines due to migration and other causes. Further, since an allowance is produced for the layout of the signal lines, advantage is afforded to designing in realizing a liquid crystal display device of high fineness of display and small pixel pitch.

The structure of FIG. 15 may not necessarily be employed in the present invention.

It is obvious that the structure of FIG. 15 is also of use in a liquid crystal display device of the data transfer system not using the Ag alloy/Mo alloy laminate film for the bus lines GBL, DBL.

According to the present invention, as resistance of the signal lines can be reduced by use of a silver-based alloy for these signal lines, it becomes possible to realize a further reduction in size and higher fineness of display of the liquid crystal display devices. It is also possible to incorporate the data transfer system as a packaging system. Further, since a high-yield and simple manufacturing process can be applied, the production cost for the liquid crystal display device can be reduced.

What is claimed is:

1. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein:
at least one of said scanning line, said data line, and the source and drain electrodes of said thin film transistor comprises a laminated film containing a first electroconductive film and a second electroconductive film;
said first electroconductive film is made of a molybdenum-based alloy; and
said second electroconductive film is made of a silver-based alloy and disposed on said first electroconductive film.

2. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein:
each of said data lines comprises a laminated film containing a first electroconductive film and a second electroconductive film;
said first electroconductive film is made of a molybdenum-based alloy; and
said second electroconductive film is made of a silver-based alloy and disposed on said first electroconductive film.

3. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, wherein:
each of said data lines comprises a laminated film containing a first electroconductive film and a second electroconductive film;
said first electroconductive film is made of a molybdenum-based alloy;
said second electroconductive film is made of a silver-based alloy and disposed on said first electroconductive film; and
at the terminal of each said data line is formed a contact hole passing through said protective insulating film and said second electroconductive film.

4. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, wherein:
each of said data lines comprises a laminated film containing a first electroconductive film and a second electroconductive film;
said first electroconductive film is made of a molybdenum-based alloy;
said second electroconductive film is made of a silver-based alloy and disposed on said first electroconductive film;
at the terminal of each said data line is formed a contact hole passing through said protective film and said second conductive film; and
said first electroconductive film at the bottom of each said contact hole is in contact with a transparent electroconductive film.

5. A liquid crystal display device according to claim 4, wherein:
said transparent electroconductive film is made of indium tin oxide; and
said first electroconductive film is covered with said transparent electroconductive film so as not to be exposed.

6. A liquid crystal display device according to claim 4, wherein:
said transparent electroconductive film is made of amorpous indium tin oxide, indium zinc oxide or indium germanium oxide;
said second electroconductive film at the side wall of each said contact hole is covered with said transparent electroconductive film so as not to be exposed; and
at least part of said first electroconductive film at the bottom of each said contact hole is not covered with said transparent electroconductive film and is left exposed.

7. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein:
the source and drain electrodes of each said thin film transistor comprise a laminated film containing of a first electroconductive film and a second electroconductive film;
said first electroconductive film is made of a molybdenum-based alloy; and
said second electroconductive film is made of a silver-based alloy and disposed on said first electroconductive film.

8. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, gate insulating films covering said scanning lines almost entirely, and protective insulating films covering said data lines and said thin film transistors almost entirely, wherein:
the source and drain electrodes of each said thin film transistor comprise a laminated film containing a first electroconductive film and a second electroconductive film;
said first electroconductive film is made of a molybdenum-based alloy;
said second electroconductive film is made of a silver-based alloy and disposed on said first electroconductive film; and
each said source electrode has formed therein a contact hole passing through said protective insulating film and said second electroconductive film.

9. A liquid crystal display device according to claim 8, wherein:
said first electroconductive film at the bottom of said contact hole is in contact with a transparent electroconductive film.

10. A liquid crystal display device according to claim 9, wherein:
said transparent electroconductive film is made of indium tin oxide, indium zinc oxide or indium germanium oxide; and
said first electroconductive film is covered with said transparent electroconductive film so as not to be exposed.

11. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, and pixel electrodes connected to said thin film transistors, wherein:
each of said scanning lines comprises a laminated film containing of a first electroconductive film and a second electroconductive film;
said first electroconductive film is made of a molybdenum-based alloy; and
said second electroconductive film is made of a silver-based alloy and disposed on said first electroconductive film.

12. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning signal lines almost entirely, and protective insulating films covering said picture signal lines and said thin film transistors almost entirely, wherein:
each of said scanning signal lines comprises a laminated film containing of a first electroconductive film and a second electroconductive film;
said first electroconductive film is made of a molybdenum-based alloy;
said second electroconductive film is made of a silver-based alloy and disposed on said first electroconductive film; and
at the terminal of each said scanning line is formed a contact hole passing through said protective insulating film, said gate insulating film and said second electroconductive film.

13. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistors almost entirely, wherein:
each of said scanning lines comprises a laminated film containing of a first electroconductive film and a second electroconductive film;
said first electroconductive film is made of a molybdenum-based alloy;
said second electroconductive film is made of a silver-based alloy and disposed on said first electroconductive film;
at the terminal of each said scanning line is formed a contact hole passing through said protective insulating film, said gate insulating film and said second electroconductive film; and
said first electroconductive film at the bottom of said contact hole is in contact with a transparent electroconductive film.

14. A liquid crystal display device according to claim 13, wherein:
said transparent electroconductive film is made of indium tin oxide; and
said first electroconductive film is covered with said transparent electroconductive film so as not to be exposed.

15. A liquid crystal display device according to claim 13, wherein:
said transparent electroconductive film is made of amorphous indium tin oxide, indium zinc oxide or indium germanium oxide;
said second electroconductive film at the side wall of said contact hole is covered with said transparent electroconductive film so as not to be exposed; and
at least part of said first electroconductive film at the bottom of said contact hole is not covered with said transparent electroconductive film and is left exposed.

16. A liquid crystal display device according to claim 1, wherein:
each of said data lines and the source and drain electrodes of each said thin film transistor comprise a laminated film containing a first electroconductive film and a second electroconductive film;
said first electroconductive film is made of a molybdenum-based alloy; and
said second electroconductive film is made of a silver-based alloy and disposed on said first electroconductive film.

17. A liquid crystal display device according to claim 1, wherein:
each of said scanning lines, each of said data lines and the source and drain electrodes of each said thin film transistor comprise a laminated film containing of a first electroconductive film and a second electroconductive film;
said first electroconductive film is made of a molybdenum-based alloy; and
said second electroconductive film is made of a silver-based alloy and disposed on said first electroconductive film.

18. A liquid crystal display device according to claim 1, wherein:
said first electroconductive film is made of an alloy which is principally composed of molybdenum and contains at least one element selected from zirconium, hafnium, chromium and titanium.

19. A liquid crystal display device according to claim 1, wherein:
said first electroconductive film is made of an alloy which is principally composed of molybdenum and contains 23% by weight or less of zirconium.

20. A liquid crystal display device according to claim 3, wherein:
driver chips are packaged according to the chip-on-glass (COG) system;
the plural lines connected to the input side of said driver chips comprise the first line group composed of at least one line and the second line group composed of the lines not belonging to the first line group; and
said first and second line groups are arranged with the interposition therebetween of at least one of said gate insulating film and said protective film.

21. A liquid crystal display device comprising a pair of substrates, a liquid crystal layer sandwiched between said pair of substrates, plural scanning lines formed on one of said substrates, plural data lines crossing said scanning lines matrix-wise, thin film transistors disposed close to the crossing points of said scanning and data lines, pixel electrodes connected to said thin film transistors, gate insulating films covering said scanning lines almost entirely, and protective insulating films covering said data lines and said thin film transistor almost entirely, in which the driver chips are packaged according to the chip-on-glass (COG) system, wherein:
the plural lines connected to the input side of said driver chips comprise a first line group composed of at least one line and a second line group composed of the lines not belonging to the first line group; and
said first and second line groups are arranged with the interposition therebetween of at least one of said gate insulating film and said protective insulating film.
